(19) United States
(12) Patent Application Publication
(10) Pub. No.: US 2016/0335852 A1
(43) Pub. Date: Nov. 17, 2016

(54) HEART ATTACK CASINO GAME AND APPARATUS

(71) Applicant: HMD Entertainment, LLC, Rochester, NY (US)

(72) Inventor: Ronald J. Wolff, Rochester, NY (US)

(73) Assignee: HMD Entertainment, LLC, Rochester, NY (US)

(21) Appl. No.: 15/147,866

(22) Filed: May 5, 2016

Related U.S. Application Data
(60) Provisional application No. 62/157,777, filed on May 6, 2015.

(51) Int. Cl. G07F 17/32; A63F 1/00

(52) U.S. Cl. CPC G07F 17/3293; A63F 1/00; G07F 17/326; A63F 2001/003

(57) ABSTRACT

Disclosed herein are a casino game as well as the methods and apparatus for conducting the game. In one embodiment, the Heart Attack™ game includes a game table or surface (physical or virtual) on which wagering and steps of the game are carried out using playing cards to implement the game as a Blackjack or Casino War type game.

This application claims priority under 35 U.S.C. §119(e) from U.S. Provisional Application No. 62/157,777 for HEART ATTACK, filed May 6, 2015 by R. Wolff, which is hereby incorporated by reference in its entirety.

Disclosed herein are a casino game as well as the methods and apparatus for conducting the game. In one embodiment, the Heart Attack™ game includes a game table or surface (physical or virtual) on which wagering and steps of the game are carried out using playing cards to implement the game.

### BACKGROUND AND SUMMARY

The following disclosure is directed to a totally new type of casino game entitled Heart Attack™ which incorporates aspects of popular casino table games. The disclosed game, including various embodiments and alternatives, provides an enjoyable experience for the Blackjack and/or Casino War player. The game is designed to be fair to both the player and the casino house, although it easily allows for variations of betting types and odds as the house wishes. It is simplistic in design which allows the casual observer to easily understand the flow of the game and join in the fun.

The game provides for betting on two cards received with three individual wagers that must be made in unison at the start, and is enabled using a Blackjack-type table or board on a table-top or similar horizontal playing surface. In the first two wagers, players wager that the first card they receive is a Heart, and the second card they receive is a Heart.

The game does not require the player to best the dealer or another player to win. There is an opportunity after the first card is revealed for a player to double the second and third bet, but this must be done in unison. This doubling option, when exercised, increases the payout odds of both bets, which is also a unique feature of the game. This game also has a unique bonus round, where specially qualified winners are allowed to attempt to significantly increase their winnings in the round with no risk, while non-qualifying players can also participate in the bonus round but with an additional wager that is at risk. Another unique feature is the possibility of a player's losing hand to be “saved” and converted to a win depending on the dealer's lone card. By the same token, depending on the dealer's card, all players' hands can be turned into losing hands or “killed” regardless of their otherwise winning or even their bonus qualifying stature. There is a unique feature of the game where a player who is dealt the Queen of Hearts gets an increased payout on the first or second wager, or a player who is dealt two neighboring hearts (i.e. 2 and 3 of Hearts) gets a special payout.

Disclosed in embodiments herein is a method of playing a casino game, comprising: (a) providing a “deck” (physical or virtual) of 52 playing cards; (b) providing an area in which wagers may be placed by participants in a blackjack-type fashion, wherein the area includes (1) a location for each player to receive two face up cards from the dealer; (2) a location for the dealer to receive a face down card after each players' first up card is dealt; (3) a community area for subsequent winning cards to be dealt to enhance the payouts of aforementioned special qualifying players and other “at risk” participants in the bonus round. (4) an area for special qualifying players to select the number of cards to be “buried” in the discard rack by instructing the dealer to mark a circled number between 0 and 2; (5) an area at each player station to wager that the player's first card will be a Heart; (6) an area at each player station to wager that the player's second card will be a Heart; (7) an area at each player station to wager that the player's two cards together will have at least one Heart unless the player's hand is “saved” by the dealer's card; (8) a graphic which describes the various hand killing or hand saving cards in a semi-circle on the layout which serves to delineate the players' area from the dealer's area; (9) an area at each player station for non-qualifying bonus players to participate in a bonus round by wagering; (c) the game being played by the following steps, (1) the player(s) commence wagering; (2) a dealer manually or mechanically dispenses a face up card to each of 1 to 7 players at their table station; (3) player(s) with this first card being of the Heart suit are paid, losing first card wagers are removed, and player(s) can then exercise the option of doubling their remaining two bets; (4) the dealer places a face down card at the player's designated area; (5) the dealer places a second face up card to each player at their station; (6) player(s) with this second card being of the Heart suit are paid, losing second card wagers are removed; (7) if there are one or more special qualifying players with two Hearts, they can participate in a bonus round at no risk, so at this time other players are now asked if they want to participate at risk; (8) the dealer reveals the dealer's face down card by turning it up; (9) the dealer settles all immediate winning and losing hands but unless the dealer's card was a “Kill” card for the dealer to win all hands, leaves special qualifying player hands of players' two cards being hearts unsettled for further play (if there are no qualifying hands go to step (14)); (10) the special qualifying player furthest to the dealers left selects the number of cards he or she wants buried between 0 and 2 and the dealer marks the corresponding number and either doesn't bury {0} or buries 1 to 2 cards before the next card is revealed; (11) if the revealed card is a Heart, the round continues and the next eligible qualifying player selects the number of cards to be buried before the next revelation, and (12) the process continues as long as the revealed card is a Heart. (13) When the revealed card is not a Heart, the round ends and all the special qualifying players' bets are settled. The “at risk” bonus participants lose if the Heart Bonus total is less than four, otherwise they win at the same odds as the qualifying participants. (14) The next round commences.

Further disclosed in embodiments herein is the casino game wherein the wagering area and card presentation area are displayed on a video display, and where wagers are placed by players via a user interface such that the wagers are depicted on said display.

Also disclosed herein is a casino game “board” comprising a wagering area in which wagers may be placed by a participant(s) in a blackjack-type fashion, wherein said wagering area includes: (1) separate player stations where each of 1 to 7 players receives two cards face up; (2) an area at each player station for player wagering on whether or not the player's two face up cards dealt will consist of one or more cards of the Hearts suit; (3) an area at each player station for player wagering on whether or not the player's first face up card dealt will be of the Hearts suit; (4) an area at each player station for player wagering on whether or not the player's second face up card dealt will be of the Hearts suit; (5) an area for placement of a dealer face down card after the first of the two face up cards are dealt to each player; (6) an area for placement of further community face up cards in front of the dealer to potentially enhance the payouts to specially qualifying player(s) that had two face up cards, both of the Hearts suit, at their respective station(s) as well as other voluntary “at risk” participants; (7) an area for special qualifying players to select the number of cards to be “buried” in the discard rack before the next card is revealed by marking a circled number between 0 and 2; and (8) an area for non-qualifying players to Piggy Back™ off of special qualifying players for a potential “Bonus Round” by making an “at risk” wager.

The disclosed game has odds for each type of wager that have been researched and tested with trials using computer methodology. These odds, and possible payouts, will be discussed in the detailed description of the game. This is not to suggest that the game is dependent on the stated odds and that changing the odds and payouts will fundamentally alter the game or create a new type of game. It is quite possible that a casino or state gaming commission may wish to alter the odds and/or payouts for the benefit of either the players or the casino establishment.

### BRIEF DESCRIPTION OF THE DRAWINGS

FIG. 1 is an illustration of the game board layout in accordance with one embodiment of the Heart Attack game;

FIGS. 2 and 3 depict a flow chart describing the order and mechanics of the game play per round;

FIG. 4 depicts a spreadsheet calculation of casino advantages for a normal game, doubling after the first card, and at risk bonus round participation;

FIG. 5 depicts a spreadsheet calculation of probabilities of different winning possibilities of the first two player bets;

FIG. 6 depicts a spreadsheet calculation of all possibilities of the third player bet;

FIG. 7 depicts results of five years of game play using parameters which will be discussed; and

FIG. 8 is an illustrative example of a video gaming system in accordance with one embodiment of carrying out the Heart Attack game.

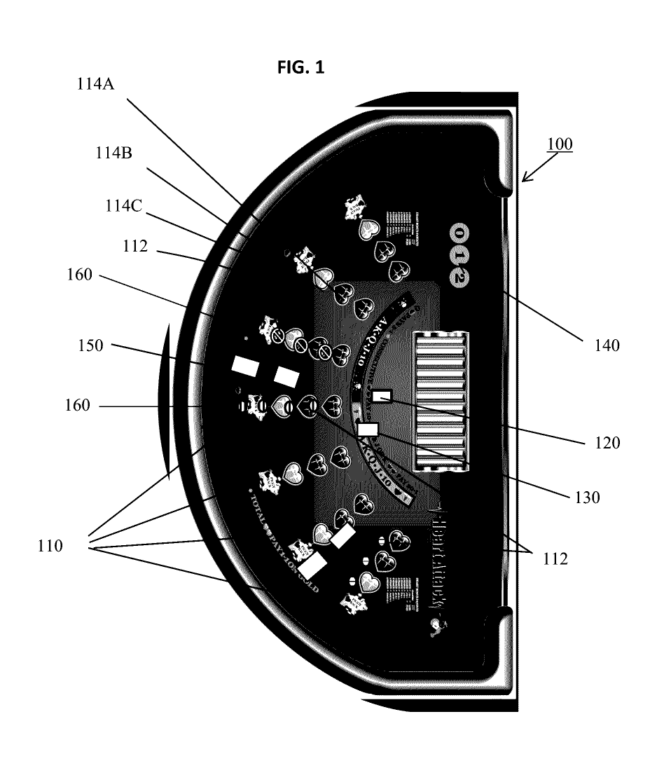

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawing in FIG. 1. In the drawing, like references have been used throughout to designate identical or similar elements. It is also noted that the drawing may not have been drawn to scale and that certain regions may have been purposely drawn disproportionately so that the features and aspects could be properly depicted.

### DETAILED DESCRIPTION

Referring initially to FIG. 1, depicted therein is an exemplary game board layout 100 for the Heart Attack casino game. Although described relative to FIG. 1 as an example, it should be appreciated that various layouts and modifications may be employed to facilitate the playing of the game in either a physical or virtual (i.e. computer-based) manner, and that all such layouts and modifications are intended to be included within the scope of this description. For purposes of illustration, certain face cards are represented in game boards and the like, or in the figures and description herein, using capital letters “A” for Ace, “J” for Jack, “Q” for Queen and “K” for King. The suits may be represented in small or large letters by “s” for Spades, “h” for Hearts. “c” for Clubs and “d” for Diamonds, providing an area of description for which dealer cards affect the outcome of the game, and this may be done on a physical table or board, or on a virtual (video) interface.

Providing an area 110 in which wagers may be placed by participants in a blackjack-type fashion may be done on a physical table or board, or on a virtual (video) interface. A wagering area includes a location(s) at each player station with three designated areas 114 (e.g., heart shapes) to make the three required wagers by placing a chip 112 on the area; (1) a wager whether or not the player's first card will be of the selected, Hearts, suit (114A); (2) a wager whether or not the player's second card will be of the selected, Hearts, suit (114B); (3) the main wager of whether or not the player will be dealt at least one card of the selected, Hearts, suit out of the player's two cards (114C). The board further includes a face down card area 120 for a dealer's card(s); a face up card revelation area 130 for up to eight additional bonus cards; and three regions 140 labeled for each number of a selected number range beginning with zero (e.g., 0, 1, 2) near the dealer to respectively mark (with a marker not shown) the number of dealer buried cards that the at least one player selects during a bonus round. Player's cards are dealt into regions 150 located between the respective player wagering areas. Non qualifying players, those not winning on earlier wagers in a hand, can Piggy Back on qualified bonus players to participate in their bonus by placing an at risk bet onto the Piggy Back space beyond the three Hearts at region 160.

Although described herein in the embodiment of a casino game played within a casino on a game table, it will be appreciated that various aspects of the disclosed game may be similarly presented in an electronic game format. For example, the game may be played on a video gaming system, stand-alone or on-line, where one or more users may place wagers and perform the actions of a player (i.e., virtual player) and where the computer (local or a server-based system) performs the operations of the dealer or the “house” relative to analyzing wagers and payout out winnings. In a video gaming environment, playing of the game is contemplated wherein users may be represented by personalized avatars or similar iconic characterizations. Thus, the game may be played in a computer-simulated version or as a multi-player game where other users are similarly “on-line” and playing around the same game surface. It should be further understood that an on-line version of the disclosed game may be displayed as a simple table-top displaying wagers and cards as dealt (e.g., a top-down view of a representative playing surface), or the game may be animated and/or three-dimensional so that the actions of the players and dealers are realistically simulated (e.g., placing of wagers, dealing and revealing cards, etc.) to provide an experience as though a user were playing at a casino.

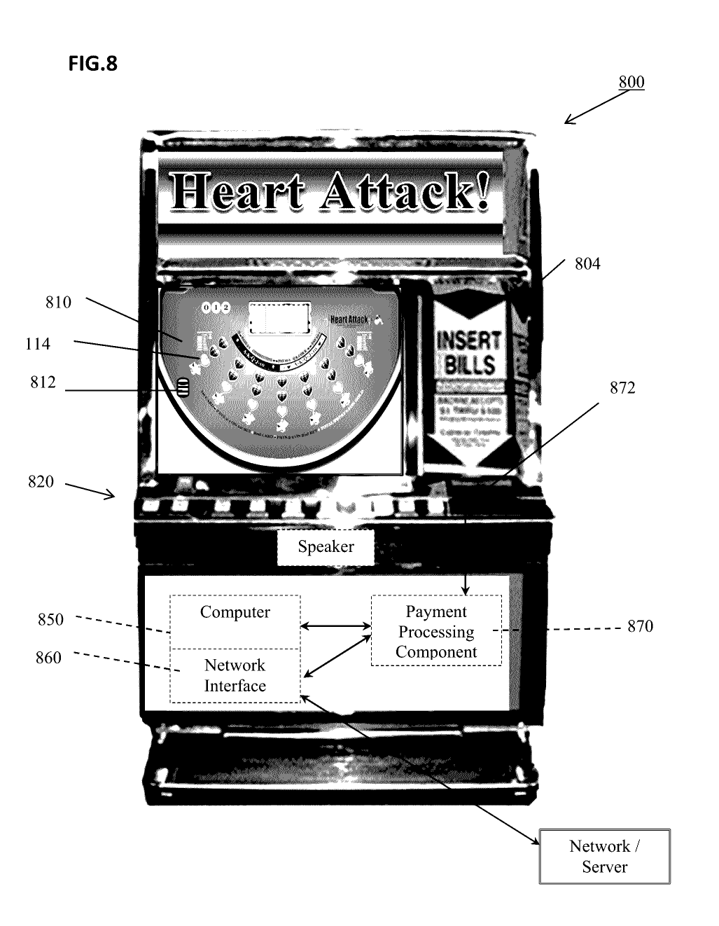

Similarly, although characterized using conventional casino components such as chips of different value, it will be appreciated that aspects of the disclosed Heart Attack game may be carried out using a digital or similar gaming table whereby at least the table surface is implemented using a large format display device, and wagers are placed by users using some form of interactive interface. As an example, similar to games provided by companies such as BingoTimes™ (http://www.bingotimes.com.tw/english/index.html) and other known video-gambling systems, a user may have a digital representation of chips on a “stack” in front of them, and even a game board. For example, briefly referring to FIG. 8, where such an embodiment is illustrated, the computer-driven gaming system 800 includes a housing or shell 804 in which various features are installed, including a gaming interface comprising both a video screen 810 (CRT, LED, LCD, touch-screen, etc.), as well as a series of buttons 820 (e.g., physical buttons, touch-screen buttons, or joystick or mouse-type interface) and similar interface elements through which the user interacts with the system to control the user's input actions. As one example, for placing wagers the user could select and drag a chip icon(s) from the player's stack 812 to one of the wagering locations identified herein (114), in the same manner that an icon can be dragged and dropped on a conventional user interface, in order to place a wager. As illustrated, the video interface includes a depiction of a game board (e.g., FIG. 1), but may also provide different screens, windows and the like to enable user interaction, game demonstration, account login/verification, single or multi-player gaming options, and the like. Likewise, in the event of a wager that pays off, the user's stack would be credited and receive additional chips upon payout. Also included in system 800 is a computer 850, a network interface 860 connecting the system to an intranet or the Internet via a wired or wireless connection, and thereby allowing a user to play against the house or other players that are at similar gaming terminals or on-line. As illustrated, such a system may be implemented via a client-server or similar architecture so as to enable one or more remote systems 800. The system further includes a payment processing component 870. In one embodiment the payment processing component 870 may be connected to a conventional coin or paper currency receiver 872 as illustrated in the embodiment of FIG. 8. In alternative embodiments, the payment receiving component may include a credit card swipe/scanner or various on-line payment mechanisms, facilitated via the network, where a user is presented with a video display prompting the user to log in to a gaming account, etc. In all scenarios, the payment processing component is suitable for arranging and authenticating the availability and/or transfer of funds from a user account in order to make such funds available for wagering via the system. Similarly, the crediting of funds is handled by the payment processing component 870 upon the user leaving or logging off from system 800.

Although it will be appreciated that wagers may be represented in monetary units where appropriate or legal, non-monetary units may be employed in such games as well. Although the disclosed embodiment is described herein in considerable detail with reference to certain versions thereof, other versions are possible. As noted above, for example, the gaming method described is not limited to being played as a table game. The game may be played as a board game or by using computers or electronic devices such as the embodiment of FIG. 8 having audio and video outputs. Thus, the term “card” as used in this application refers to traditional playing cards made of paper stock having game indicia, such as numbers (2-10), suits (Diamonds, Hearts, Spades, and Clubs), and characters (Aces, Jacks, Queens, and Kings). The term “card” is also used to refer to one of a plurality of electronic images of traditional cards. The term “dealer” may be an actual person distributing the cards. It is noted that the dealer may also be a player, and the dealer does not have to be associated with a business entity having a stake in any profits derived from operating the game. The term “dealer” may also be used to refer to a virtual dealer that is programmed through an electronic device or computer. And, the function of the dealer may also be performed, or at least assisted, by any of a number of gaming-based devices including automated card shuffling devices as well as robotic arms suitable for shuffling, dealing, revealing cards, removing wagers, etc. One example of such a device is available from Bingo Times Digital Technology Co. Ltd of Taiwan (e.g., Model R200 offers a complete Baccarat set up with an automated arm for the Banker).

The game disclosed herein can be readily implemented in a wide variety of additional forms and media including, but not limited to: single player slot video machines, multi-player slot video machines, electronic games and devices, lottery terminals, software, as well as home, and Internet entertainment. Furthermore, the game can be readily implemented in software, which can be downloaded or stored on a disk (e.g., magnetic disk, compact disc (CD), USB memory stick, etc.,) and used with a computer system. In one embodiment, the gaming method disclosed may be implemented as a computer game which may be executed via disk or downloaded from the Internet and played using a computer, gaming console, or an electronic handheld device (e.g., personal digital assistants (PDA), smart phones, etc.). Such embodiments may be played individually or may be played with other players. In another embodiment, the disclosed game may be played as an interactive online gambling game wherein the player may play against the dealer individually or with other players via the Internet. The dealer may be an actual person or a virtual dealer. Similarly, the other players may be actual people or they may be computer generated virtual players. In yet other disclosed embodiments, the gaming method may be played against a casino or wagering establishment from a remote location via the Internet.

Certain gamblers feel uncomfortable with the fast pace and frenetic activity which often accompanies multiple players around a table game such as Blackjack and Casino War. There are electronic formats found in the casino environment that provide differing levels of privacy for the player. It is possible for players to use an electronic video touch screen format to place wagers for what otherwise would be a regular table format with a dealer revealing cards, and inputting the revealed cards to a console. A Computer Central Processing Unit (CPU) or individual processors in each player's video terminal would settle wagers and tally present account totals. A similar scenario would be multiple players with individual touch screen terminals having their wagers centrally processed for computer graphic display on a large wall monitor. Another scenario would be a user or player having a private game on his/her touch screen terminal without multiplayer interaction. All of the above-mentioned scenarios have been experienced for Blackjack play at various casinos. Accordingly, it is not to be construed that only certain input device types, processing device types, or display device types could be used with the disclosed embodiments. Rather, the present disclosure contemplates the use of currently available as well as future electronic, mechanical and/or electromechanical devices and systems that may be employed to carry out one or more features and operations of the game as disclosed herein.

Another scenario is of players using individual computing devices for Internet or other networked game play. Instead of wagering being displayed on a central screen, it would be fed back to each individual computer (e.g., FIG. 8; 800) through the main website server. It is also quite possible the game could be played by individuals with downloaded software which would not involve internet interaction. This scenario would be where the user is essentially playing on and against only the computer (or possibly other simulated players), and the computer carries out the functions of the dealer or house. Another scenario would involve a portable cellular or smart phone device being used with a downloaded application to play the game. Since the game board size may create visual issues on small screens, a “zoom in” ability is envisioned, where the board could be scrolled (e.g., using known gestures, navigational buttons or techniques) for betting or game play purposes. Only parts of the board would likely be on display at one time with this type of device, but this is not to construe that the game would be fundamentally changed with any board depiction which deviates from the described board, even though there may be modifications in order to permit a more user-friendly video display. Nor should it be construed that the screen size of the portable device is a factor requiring fundamental change. Nonetheless, the layout or format of the game board may be modified in order to permit ease of use or wagering via hand-held or other portable devices.

The game can also be played in home table form for private party purposes. It can be marketed and used as any other board game with or without electronic components. For example, an electronic card shuffler and card revealer could be envisioned for an otherwise manual board game. A designated dealer can manually do these tasks as well, which is the manner in which the board for a private party is envisioned to be used.

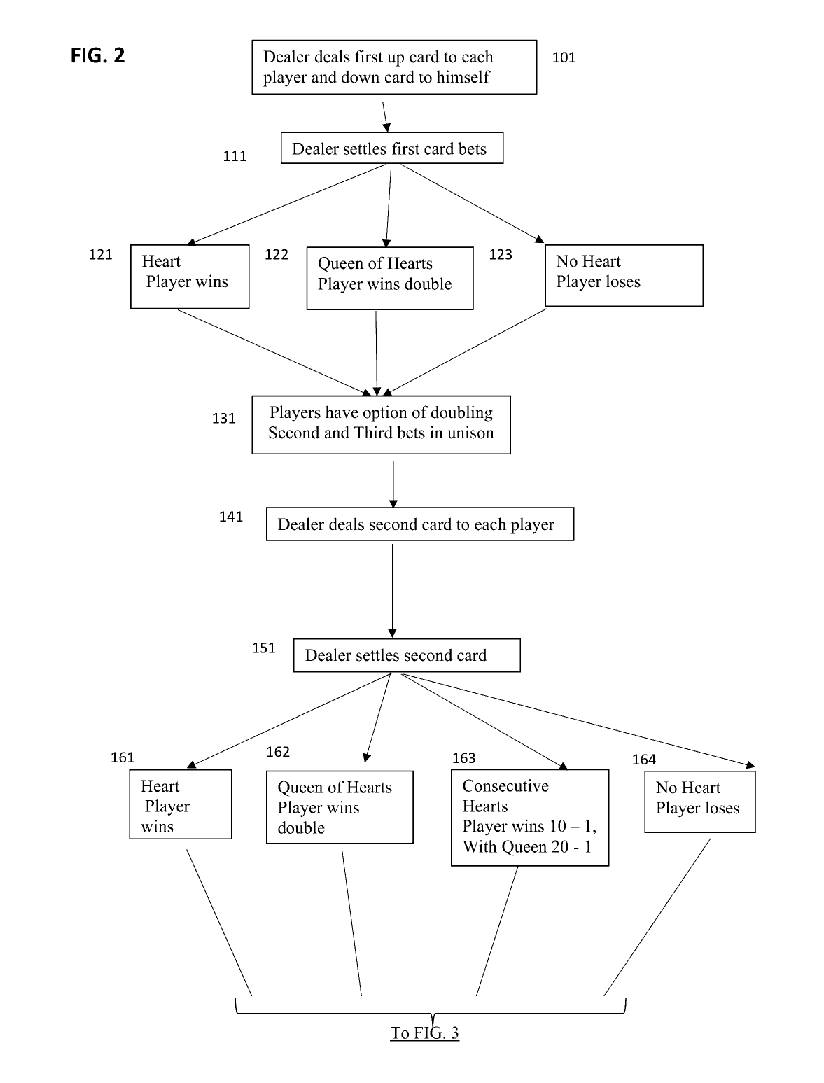

Having described the general layout of the playing board or surface, as well as several virtual game embodiments and with the various bets that can be played thereon, attention is next turned to the manner of playing an exemplary game. Referring also to FIGS. 2 and 3, the game may be played by the following steps, and as noted relative to the description of a gaming embodiment depicted in FIG. 8, such steps may be carried out by a series of programmatic instructions executed on a computer (client or server level), so as to provide a virtual or video gaming experience. First, (see FIG. 2, 101) the player(s) commence wagering at their particular station in locations around the player side of the table. They each place three equal wagers at three spaces in their respective stations. Next the dealer takes a freshly shuffled deck by either manual or mechanical means and dispenses a face up card to each player. He then settles the first wager of the players as to whether or not it is a Heart (see FIG. 2, 111). Those players with Hearts dealt are paid at 2 to 1 (see FIG. 2, 121). If a player receives the Queen of Hearts the player increases the return at 5 to 1 (see FIG. 2, 122). The dealer then offers all players the one time opportunity to double their last two bets, but both must be doubled in unison and not as a choice of which of the two bets to double (see FIG. 2, 131). He then deals a face down card to himself, and then a second face up card to each player (see FIG. 2, 101,141). Any player who has received the second card as a Heart is paid 2 to 1, the Queen of Hearts at 5 to 1, while losing second card wagers are removed (see FIG. 2, 151, 161,162,163,164). The dealer then observes if there are any special qualifying players that have been dealt two Hearts (see FIG. 3, 201). If there are any of these players, he firstly observes if their two Hearts are consecutive (i.e. 2 and 3, Ace and King or Ace and 2 of Hearts). If that is the case, the player also gets a 10 to 1 bonus, unless the second card was also the Queen, where they would then get a 20 to 1 bonus (see FIG. 2, 163). These players are also potential “no risk” specially qualified bonus round participants. He then offers all players the opportunity to risk a new wager at the first card wagering space to participate in the potential bonus round. If the bonus round proceeds and gets to the fourth Heart, then these other players are said to have “won” and will receive the same payout as the special qualifying players that are not at risk, otherwise they have “lost” the risked wager (see FIG. 3, 211). Next, the dealer reveals the player's face down card (see FIG. 3, 221). If the player's card is either the 10, Jack, Queen, King or Ace of Spades, he will be said to have “killed” the hand and all players lose their third and remaining wagers on the board, whether or not they were dealt one or two cards of the Hearts suit and thus regardless of if they had been a winner otherwise (see FIG. 3, 231). If the dealer's revealed card is the 8, 9, 10, Jack, Queen, King or Ace of Hearts, All players winning hands are not only considered “safe” but all players' normally losing third bets become automatic winners (see FIG. 3, 232). If any of the otherwise losing players had exercised the “double” option of doubling their bets after the first card, their payout is doubled. If the dealer's card is of any other face and suit, any player station that has no Heart suit among the two face up cards has lost and the player's wager is removed. Any player that has one card of the Heart suit has won and is paid even money for the wager. Players that have one card of the Hearts suit and opted to double their second and third wager at the decision point get a double payout. Any player whose both cards are of the Hearts suit has specially qualified for the “bonus” round with the potential for much higher payouts, as long as the dealer's card was not a “Kill” card. Any player who elected to place an additional wager to participate “at risk” in a potential bonus round is also a part of the round unless the dealer's card “kills” them also.

The bonus round commences as follows: Firstly, if the dealer's revealed card was any Heart regardless of face, the qualifying player(s) automatically achieve their third Heart for a three Heart count (see FIG. 3, 242); if the dealer's card is not a Heart, the player(s) continue the bonus round starting with their two Hearts already present at their station and a two Heart count (see FIG. 3, 243). The special qualifying player to the left-most of the dealer announces if he wants the dealer to not bury a card, bury one card, or bury two cards before revealing the next card. The selection is marked on the appropriate space on the game board, if requested, cards are buried, and the next card is revealed (see FIG. 3, 252, 261). If it is a Heart, the special qualifying players now have added another heart to their total and the next eligible player (or the same if only one special qualifier) repeats the process up to their tenth Heart; if it is not, the round ends (see FIG. 3, 271, 272 283, 251). Wagers are settled for the special qualifying player(s) with enhanced payouts for three or more Hearts. For players that voluntarily participated in the bonus round with an additional wager, if a fourth heart was not achieved in the bonus round, their wagers are lost (see FIG. 3, 281). Otherwise they receive the same payout as the special qualifying players (see FIG. 3, 282). Special qualifying players are also allowed to make additional voluntary “at risk” wagers before the dealer's card is revealed if they so desire.

The only influence the dealer exerts in the game is the lone face down card at revelation, and unlike most other casino type games, the dealer is not given an equivalent hand to a player. In other words, the dealer has only five chances in 52 of negatively influencing the outcome, although it may be that the game may be modified to change the dealer's chances of either positively or negatively influencing the players. As the basic game is described above, it only allows for additional wagering either after commencement of a round by exercising the option of doubling of remaining wagers after revelation of the first card, or by participating in the bonus round with an additional “at risk” wager before revelation of the dealer card.

The suggested odds for the Heart Attack game were determined by computer trials of the game run over 15 million times as well as the probability of the wagered events occurring. A statistician has provided a thorough analysis of all the possibilities of the game as seen through the eyes of one player. This is made possible by realizing that the game is really a game of either 10 or 11 revealed cards, two cards for the player, one card for the dealer, and the potential for another group of cards revealed during the bonus round. Although it is obvious that exposed players cards during a multiplayer situation would normally affect the individual player's outcome, for the sake of analysis it can be said that these exposed cards should be imagined to be face down and as though they were the bottom cards of a 52 card deck and would not be revealed during the game.

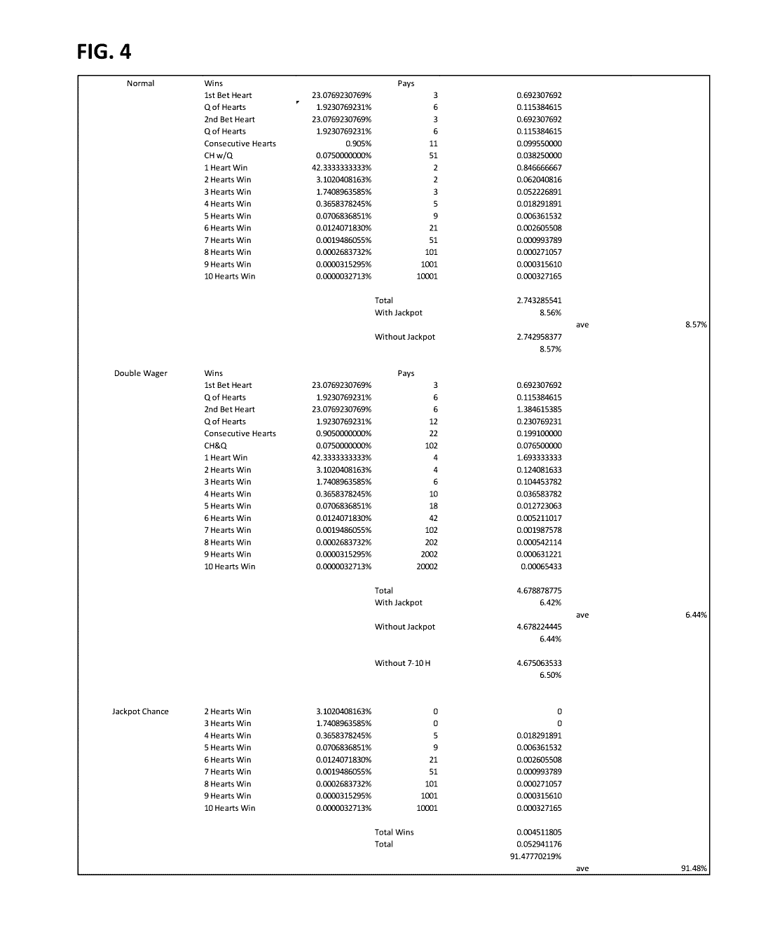

In the statistical analysis, there are 52×51×50× . . . ×42×41 or 2,411,123,563,360,510 possibilities for the first 11 cards of a random deck. Referring to FIG. 5, discussing the first two wagers in the game, there is a 13×51×50 . . . or 602,780,890,840,128,000 possibilities for a 25% chance that the first card will be a Heart. Twelve of the Heart cards pay 2 to 1, for a house advantage of 1 betting unit over the totally even odds of 3 to 1, or 25%. Out of the 25%, there is a 1/13 or 1.923% chance of being dealt the Queen of Hearts and being paid 5 to 1. If 75% of the time the house gains a unit bet, 23.077% of the time the house pays 2 units, and 1.923% of the time the house pays 5 units, the house advantage can be calculated by multiplying 23.077×2=46.154 plus 1.923×5=9.615 to get 55.769. If the house loses 55.769 units for every 75 it gains, then it gains a net 19.23.19.23/75=0.2564 or a 25.64% house advantage on the first bet.

There is a 39×13×50 . . . ×42×41 or 460,950,092,995,392,000 possibilities of the second card being a Heart without the first card being one. There are 13×12×50 . . . ×42×41 or 141,830,797,844,736,000 possibilities of both the first and second cards being Hearts. Added together, there are the same total possibilities as the first card or 25%. Using the same addition of two possibilities for the second card being a Queen the same 1.923% probability is obtained for the same 25.64% house advantage.

If both cards are Hearts and neighboring (i.e. Ace-King of Hearts, Ace-Two of Hearts, Seven-Eight of Hearts), the payout is 10 to 1 and there is a 0.98% chance of this occurring. Out of the 0.98% there is a 0.075% chance of having consecutive Hearts with the second card being the Queen, so there are 0.98%-0.075 or 0.905% probability of having consecutive Hearts without the second card Queen. By the same reasoning, 1.923% chance of having the second card queen—0.075% chance of having it joined by consecutive Hearts equals a 1.848% chance of having just the second Queen. Subtracting the 0.905%, the 1.848%, and the 0.075% from the 25% chance of the second card Heart leaves 22.172%. So if 22.172%×2=44.34 plus 1.848%×5 units=9.24 plus 0.905%×10 units=9.05 plus 0.075×20 units=1.5 units, the house pays out 64.13 units on the second card for every 75 it takes in, and the house has a net 10.87 units. This becomes a house advantage for the second bet of 10.87/75=14.49%. The average for the first two bets is (25.64%+14.49%)/2=20.065%. If the player elects to take the doubling option of the last two bets, he lowers the house advantage to (25.64%+14.49%+14.49%)/3=18.21%. Although these advantages appear very high and may be a concern for some state gambling commissions, the odds can be altered without altering the spirit or scope of the game. The third bet has such narrow odds that it brings the house advantage well below 5% which is a smaller advantage than a Roulette bet on a single number.

Analyzing the odds of the main third wager is a much more complex discussion. The structure of the deck is described from the point of view of the dealer's card using 1) a capital “K” to represent the 5 “Kill” cards in the deck; 2) a capital “H” to represent the 7 “Save” cards in the deck; 3) a small “h” to represent the 6 other Hearts in the deck; and a small “x” for the remaining 34 neutral cards that have no bearing on outcomes.

The following classes of orderings were then created for all possible situations: (A) No Hearts among the first two cards; (B) One Heart and one non-“Kill” card among the first two cards; (C) One Heart and one “Kill” card among the first two cards; (D) Both the first and second cards being Hearts and the dealer card being a “Kill” card; (E) Both the first and second cards being Hearts and the dealer card being neutral; and (F) The first two cards and the dealer card being Hearts. The following list breaks these classes into their orderings:

A1) Orderings which contain no Hearts among the first two and a non-“H” (saving Heart) as the third. Outcome=Loss

A2) Orderings which contain no Hearts among the first two and a saving Heart “H” as the third. Outcome=Win 1 to 1

B1) Orderings which have a Heart first, a non-Heart Non K (Kill) second, and a K as the third. Outcome=Loss

B2) Orderings which have a Heart first, a non-Heart non-K second, and a non-K as the third. Outcome=Win 1 to 1

B3) Orderings which have a non-Heart non-K first, a Heart second, and a K as the third. Outcome=Loss

B4) Orderings which have a non-Heart non-K first, a Heart second, and a non-K as the third. Outcome=Win 1 to 1

C1) Orderings which have a Heart first, a K second, and a K as the third. Outcome=Loss

C2) Orderings which have a Heart first, a K second, and a non-K as the third. Outcome=Win 1 to 1

C3) Orderings which have a K first, a Heart second, and a K as the third. Outcome=Loss

C4) Orderings which have a K first, a Heart second, and a non-K as the third. Outcome=Win 1 to 1

D1) Orderings which have a Heart first, a Heart second, and a K as the third. Outcome=Loss

E1) Orderings which have a Heart first, a Heart second, a non-Heart non-K as the third, and a non-Heart as the fourth. Outcome=Win 1 to 1

E2) Orderings which have a Heart first, a Heart second, a non-Heart non-K as the third, a Heart as the fourth, and a non-Heart as the fifth. Outcome=Win 2 to

E3) Orderings which have a Heart first, a Heart second, a non-Heart non-K as the third, a Heart as the fourth and fifth, and a non-Heart as the sixth. Outcome=Win 4 to 1

E4) Orderings which have a Heart first, a Heart second, a non-Heart non-K as the third, a Heart as the fourth, fifth and sixth, and a non-Heart as the seventh. Outcome=Win 8 to 1

E5) Orderings which have a Heart first, a Heart second, a non-Heart non-K as the third, a Heart as the fourth through seventh, and a non-Heart as the eighth. Outcome=Win 20 to 1

E6) Orderings which have a Heart first, a Heart second, a non-Heart non-K as the third, a Heart as the fourth through eighth, and a non-Heart as the ninth. Outcome=Win 50 to 1

E7) Orderings which have a Heart first, a Heart second, a non-Heart non-K as the third, a Heart as the fourth through ninth, and a non-Heart as the tenth. Outcome=Win 100 to 1

E8) Orderings which have a Heart first, a Heart second, a non-Heart non-K as the third, a Heart as the fourth through tenth, and a non-Heart as the eleventh. Outcome=Win 1,000 to 1

E9) Orderings which have a Heart first, a Heart second, a non-Heart non-K as the third, a Heart as the fourth through eleventh. Outcome=Win 10,000 to 1 or Jackpot

F1) Orderings which have a Heart as the first through third cards, and a non-Heart as the fourth. Outcome=Win 2 to 1

F2) Orderings which have a Heart as the first through fourth cards, and a non-Heart as the fifth. Outcome=Win 4 to 1

F3) Orderings which have a Heart as the first through fifth cards, and a non-Heart as the sixth. Outcome=Win 8 to 1

F4) Orderings which have a Heart as the first through sixth cards, and a non-Heart as the seventh. Outcome=Win 20 to 1

F5) Orderings which have a Heart as the first through seventh cards, and a non-Heart as the eighth. Outcome=Win 50 to 1

F6) Orderings which have a Heart as the first through eighth cards, and a non-Heart as the ninth. Outcome=Win 100 to 1

F7) Orderings which have a Heart as the first through ninth cards, and a non-Heart as the tenth. Outcome=Win 1000 to 1

F8) Orderings which have a Heart as the first through tenth cards. Outcome=Win 10000 to 1 or Jackpot.

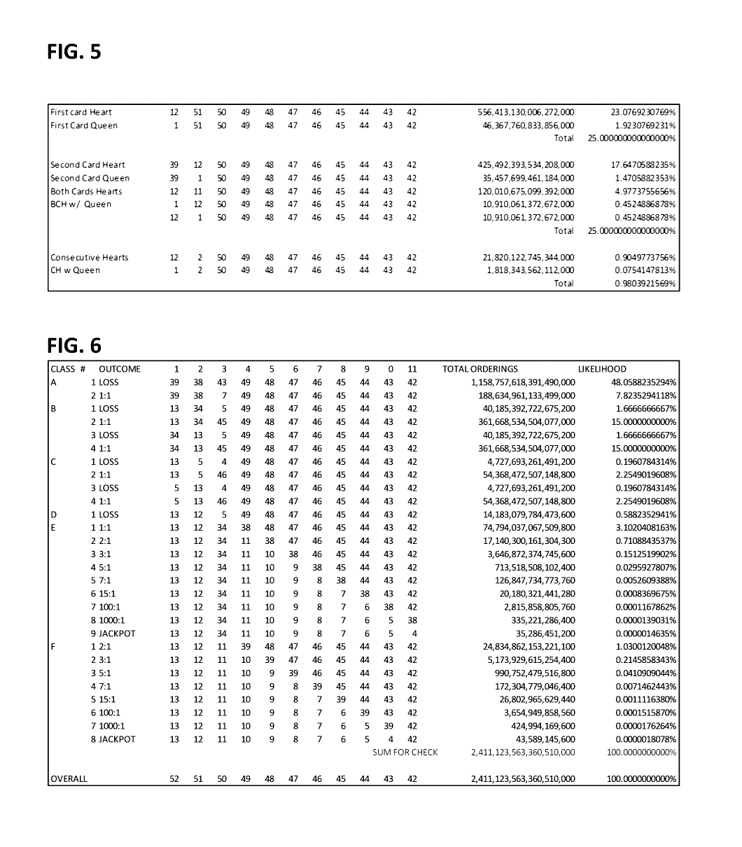

FIG. 6 shows these Classes, Orderings and their respective probabilities.

Once these probabilities are established, the two other game options, the doubling of the second and third bets and the “at risk” participation in the bonus round can be inserted as altered payouts to determine house advantages.

The following percentages are derived from the analysis described above:

| | | | |
|---|---|---|---|
| Total Player Loss | 52.37% | | |
| 1 Heart win | 42.33% | 2 units payout | 84.66% |
| 2 Heart wins | 3.10% | 2 units | 6.20% |
| 3 Heart wins | 1.74% | 3 units | 5.22% |
| 4 Heart wins | .366% | 5 units | 1.83% |
| 5 Heart wins | .071% | 9 units | .639% |
| 6 Heart wins | .0124% | 21 units | .26% |
| 7 Heart wins | .0019% | 51 units | .096% |
| 8 Heart wins | .000268% | 101 units | .027% |
| 9 Heart wins | .0000315% | 1001 units | .032% |
| 10 Heart wins | .00000327% | 10001 units | .033% |

The total of the last column percent multiplier is 98.997%. This means the house advantage is 1.003%. Since all three bets must be made equally, and the house advantages are much higher on the first two bets, the house maintains a substantial advantage.

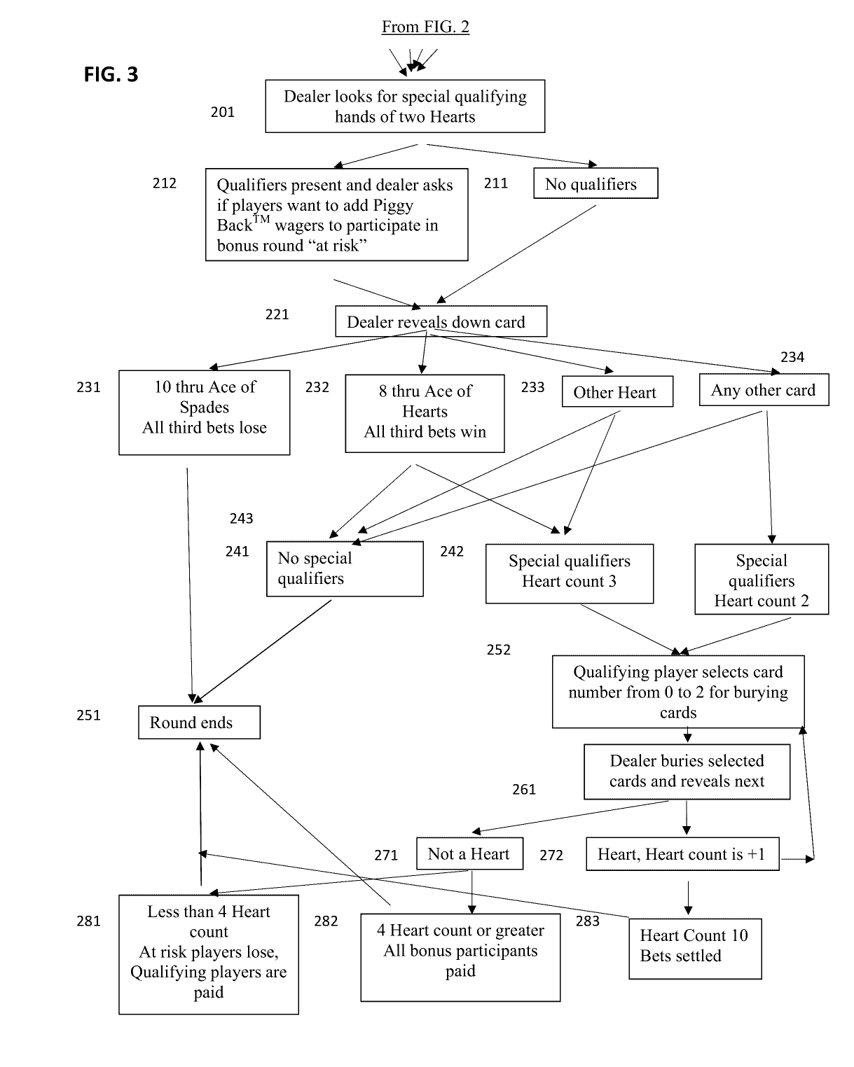

FIG. 4 shows the house advantages for the entire game of Heart Attack in three different scenarios. The first is a normal wagering situation without any options being exercised by the player and yields a house advantage of 8.57% for all three bets combined. The second is if the player decides to exercise the option of doubling the second and third bets and yields a house advantage of 6.44%. The last is the scenario of a non-specially qualified player participating in the bonus round “at risk” of losing their wager, and is like purchasing a lottery ticket with its 91.48% house advantage.

In yet another alternative embodiment, the manner of playing an exemplary game is characterized from the perspective of the dealer, where the specific actions carried out by the dealer are represented in the flowchart of FIG. 2, and described in conjunction with the game-board layout of FIG. 1. As noted previously, the game may be played on a number of surfaces, and the layout of FIG. 1 is intended to be employed with a conventional black-jack style playing table or surface (e.g., a table of approximately 70-80 inches in length by approximately 40-50 inches in width and having at least one curved edge for players to sit or stand along), although a suitable rectangular-shaped table could suffice as well. Moreover, a card-dealing system may be placed on or adjacent the surface.

Initially, the game begins when the player places bets or wagers on the three spaces in front of them in equal amounts. Then the dealer puts out or deals a first card face up to each player. He then deals a face down card in front of him in the dealer's area, the dealer's area being delineated from the players by a solid graphic semicircle describing the various hand killing and hand saving cards (FIG. 2; 101).

The dealer then settles all bets that the first card dealt to the player would be of the Heart suit (FIG. 2; 111,121,122,123). He then asks the players if they wish to exercise the option of doubling the second and third bets (FIG. 2 131), and those players wishing to exercise this option place an equal amount of new chips in their respective second and third wagering areas.

Next, the dealer puts out or deals a second card face up to each player and settles all bets that the second card would be of the Hearts suit (FIG. 2; 141,151,161,162,163,164).

The dealer then scans the table to see if any player received both cards of the Heart suit and is a potential special qualifier for the bonus round (FIG. 3; 201). If at least one player is in this special situation, then the dealer asks all players if they wish to exercise the option of participating in the bonus round as “at risk” participants who are wagering that the special qualifying player(s) will obtain at least two extra cards of the Hearts suit besides their original two for a total of four hearts or more. Those players (including special qualifying players) that wish to do so place an equal wager to their third wager on their Piggy Back spot (FIG. 3; 212). The dealer then reveals his down card (FIG. 3; 221).

If the dealer's revealed card is a Royal Spade (i.e. Ace through Ten of the spades suit) the round is said to be “killed” and all players lose their third wagers regardless of if they had at least one card of the Hearts suit or if they had both cards Hearts and were otherwise special qualifying bonus round participants (FIG. 3; 231). All players who had exercised the option of being an additional bonus round participant lose these wagers also.

If the dealer's card is of the Hearts suit and is an Eight or higher in value (with Aces being the highest value), any player that had neither card of the Hearts suit and would normally lose the third bet, wins it instead and is said to be “saved” as though they had a card of the Heart suit (FIG. 3; 232).

If the dealer's card is any card of the Hearts suit, any player that was specially qualified for the bonus round, and all other “at risk” participants are said to have achieved their third Heart automatically (FIG. 3; 233).

If the dealer's card is any other card it is considered a neutral card with no bearing on a player's outcome. Any specially qualified players will still be eligible for the bonus round but will start with a Heart count of two (FIG. 3; 234).

If there are no special qualified players, all third bets are settled and a new round commences (FIG. 3; 241). If there one or more special qualified players, all unqualified players third bets are settled, but the qualified player(s) third bets remain, as well as any bonus round “at risk” participants in the first betting spot, for possible further increase in payout.

In the bonus round, the specially qualified player to the left-most area from the dealer selects the number of cards to be “buried” or kept face down before the next bonus card is revealed (FIG. 3; 252). This choice can be either zero, one or two cards, and the dealer marks the choice with a dealer marker into the appropriate “0”, “1” or “2” space in the dealer area of the board. He then buries the appropriate number of cards or doesn't bury a card if the choice was “zero”, and reveals the next card (FIG. 3; 261). If the card is of the Hearts suit, the bonus continues with the next qualifying player to the dealer's left making the burying selection unless only one player qualified (FIG. 2; 272,252). Then that player will be the only person choosing card burying amounts.

This process continues until a non-Heart is revealed (FIG. 3; 271). If the Heart count ends less than four, all non-qualifying “at Risk” players have lost their additional wager (FIG. 3; 281), otherwise all participating players bets and qualifying players third bets are paid at the appropriate odds for the Heart count (FIG. 3; 282). A new round then commences (FIG. 3; 251).

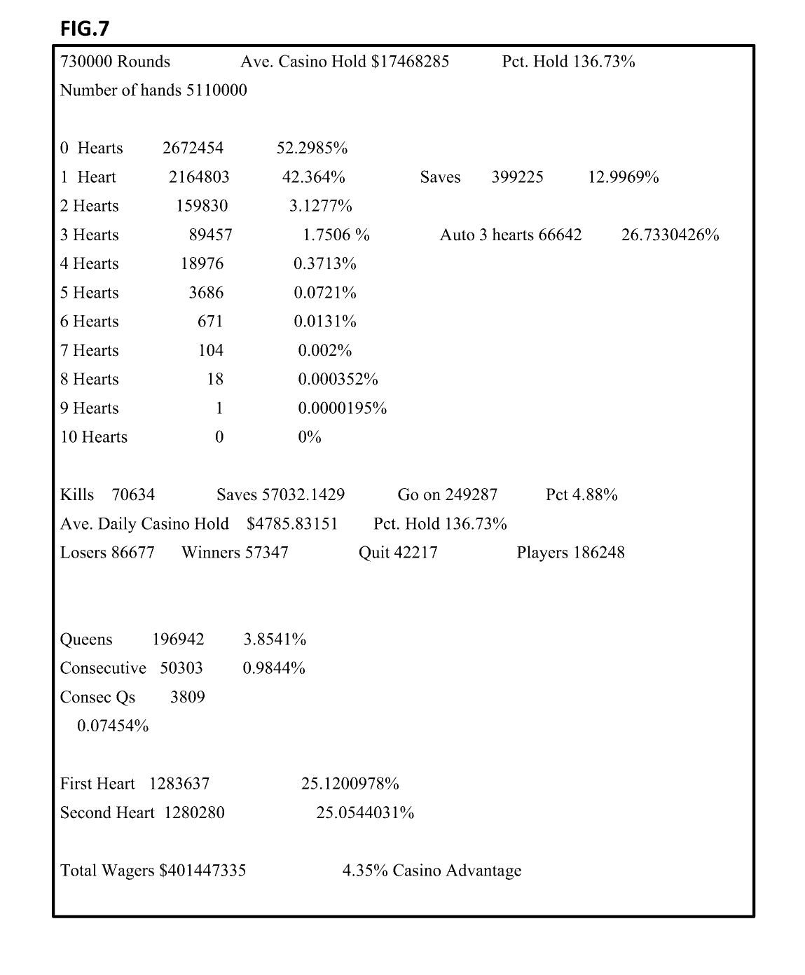

Turning briefly to FIG. 7, depicted therein is a computer printout representing the result of an exemplary simulation for one embodiment of the Heart Attack game disclosed above. In the figure, there is an assumption that the game is played with seven players, with wagers ranging from $0 to $25. The trials represented were conducted using random card generation and are intended to illustrate exemplary outcomes over various trials. Players were each given $500 and were replaced with a new player with fresh money when their money went to zero. They were also replaced if they doubled their money and left the casino as a winner or they had played 120 rounds which would be around three hours of play with no winning or losing conclusion. When there was one or less revealed Hearts when players first cards were dealt, then every other player would exercise the option of doubling their second and third bets with one exception. Any player who was dealt an initial Heart and won the first bet would automatically double their bet, because they were 90.38% assured of a minimum of breaking even by winning the third bet with their first card Heart, the remaining 9.62% being the probability of a dealer “kill” card. When there were three or less revealed total Hearts when players' second cards were dealt, then every other player would elect to be an “at risk” participant in any potential bonus round. Every 200 rounds, which is what could be expected with a shift change every six hours for 400 rounds in a 12 hour day, the casino till was reset so that the house “hold” was constantly updated.

FIG. 7 is the printout illustrating the potential revenue a casino may obtain in 5 years of play based upon the varying factors just discussed. For example, in the top example, assuming 40 hands/hour, (a very conservative estimate), the house could expect an annual revenue of $17,468,285/5 or $3,493,657.

Although the disclosed embodiments suggest up to seven players, it will be appreciated that the game layout and table orientation, and the on-line or video-gaming embodiments described above, could facilitate more or fewer players, and the disclosed embodiments are not intended to indicate a particular number of players or limit on the number of players.

It will be further appreciated that while several examples or techniques for placing wagers have been described, there are various alternatives that may be employed to reflect or record the wagers of players or users of systems that implement the disclosed game. For example, in a computer-based implementation, the user's selection (e.g., mouse-click) of a wagering location may result in an auxiliary menu (e.g., drop-down menu) with various wagering amounts for selection or representations of casino chips of various denominations. And, once made, the wagers may be illustrated in various ways using alternative background or foreground colors, shading, etc. It may also be possible to simulate the physical game, by providing a movable “chip” that can be placed or dragged/dropped on a wagering location. The details of such wagering techniques are not disclosed herein as they are believed to be known relative to other on-line and portable or hand-held casino gaming technologies.

The following alternatives or modifications are also contemplated:
The odds used in this game are suggested odds, and can be adjusted to alter the outcomes discussed above.
The named suit(s) used in this game are suggested suits, and can be substituted without altering the outcomes discussed above.
The number of cards dealt to each player are suggested and can be added to or subtracted from without altering the spirit and scope of the game as discussed above.
The number of betting spaces and betting options are suggested and can be added to or subtracted from without altering the spirit and scope of the game as discussed above.
The factors determining betting being made at each space of each individual player station are suggested and can be substituted without altering the outcomes discussed above.
The number of dealer face down cards dealt are suggested and can be added to or subtracted from without altering the spirit and scope of the game as discussed above.
The quantity of cards which determine if a player wins the third wager regardless of his two cards dealt are suggested and can be added to or subtracted from without altering the spirit and scope of the game as discussed above.
The quantity of cards which determine if a player loses the third wager regardless of his two cards dealt are suggested and can be added to or subtracted from without altering the spirit and scope of the game as discussed above.
The number of cards buried before card revelation in the bonus round are suggested and can be added to or subtracted from without altering the spirit and scope of the game as discussed above.
The number of cards revealed during the bonus round are suggested and can be added to or subtracted from without altering the spirit and scope of the game as discussed above.
The ability to double the second wager after settlement of the first wager is suggested and can be substituted without altering the outcomes discussed above.
The ability to participate in a potential bonus round by placement of an extra wager before revelation of the dealer's face down card is suggested and can be substituted without altering the outcomes discussed above.
The methods described above wherein at least a portion of at least one of the wagers is retained for future payout in a progressive pot if desired.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A method of playing a casino game, comprising:
(a) providing a deck of 52 playing cards.
(b) providing a wagering and card play area in which wagers may be placed by participants in a Blackjack-type fashion, wherein the area includes individual player stations with three individual areas (e.g., in a line from the dealer's area to the player in order) for the player to make the three wagers of the game as well as an area to receive two cards from the dealer;
(c) a dealer area to receive the dealer down card as well as further revealed cards during the bonus round;
(d) another area with spots labeled “0”, “1”, and “2” for the dealer to mark the players' selection of the amount of cards buried before card revelation during the bonus round;
(e) the game being played by the following steps:
(1) at least one player makes three equal wagers placed on the three wagering spaces in front of them at their individual station;
(2) the dealer distributes a first card to the at least one player followed by a down card to the dealer;
(3) the dealer settles the at least one player's first wagers by removing losing wagers and paying any player dealt a card of the named suit;
(4) the dealer asks the at least one player if they wish to double their second and third wagers and the at least one player, if so inclined, places another equal wager on each of the at least one player's second and third wager;
(5) the dealer distributing a second card to each of the at least one player having selected to double the bet;
(6) the dealer settling the at least one players' second wagers by removing losing wagers and paying any player dealt a card of the named suit;
(7) the dealer determining if there are any potential special qualifying players remaining with two named suit at their station and if there are, offering all players the opportunity to participate in the potential bonus round “at risk” by placing an additional wager equal to the amount on their third wager space onto a Piggy Back space;
(8) the dealer revealing the down card;
(9) the dealer settling all third bets;
(10) if there is no bonus round, continuing at step (15),
(11) if there is a bonus round, a special qualifying player selecting whether to have one of a selected number range of cards buried before the next bonus card is revealed;
(12) revealing the next bonus card and if the card is not of the named suit, the round ends and special qualifying player's third wager and other bonus round participants extra wagers are settled;
(13) if the card is of the named suit, the round continues with a next eligible special qualified player selecting to have one of a selected number range of cards buried before the net bonus card is revealed;
(14) step (12) is repeated until a total of ten cards of the named suit including the special qualifying players two cards of the named suit, and then
(15) the round ends.

2. The method according to claim 1, where subsequent rounds are completed by repeating step (e).

3. The method according to claim 1, wherein at least a portion of at least one of the wagers is retained for future payout in a progressive pot if desired.

4. A casino game board comprising three wagering areas for each of up to seven individual player stations, in which wagers may be placed by at least one participant in a blackjack-type fashion, wherein said wagering area includes:
(1) an area for wagering that the at least one player will receive a minimum of one card of the named suit in two revealed face cards and the dealer will not reveal a Ten through Ace of the Spades suit as a previously face down card, or that the dealer will reveal a Nine through Ace of the named suit regardless of what the individual player is dealt;
(2) an area to wager that the at least one player's first card will be of the named suit; and
(3) an area at each player station to wager that the at least one player's second card will be of the named suit.

5. The casino game board according to claim 4, further comprising a face down card area for a dealer's card.

6. The casino game board according to claim 4, further comprising a multiple face up card revelation area for up to eight additional bonus cards.

7. The casino game board according to claim 4, further comprising three regions marked for each number of a selected number range beginning with zero near the dealer to respectively mark the number of dealer buried cards that the at least one player selects during a bonus round.

8. The casino game board according to claim 4, wherein the board is present on a surface of a table.

9. The casino game board according to claim 4, wherein the board is presented on an electronic display as an electronic game.

10. The casino game board according to claim 9, wherein the electronic game includes an option for a user to select single player or multiplayer settings.

11. The casino game board according to claim 4, wherein the board is presented as part of a portable electronic game for a mobile device.

12. The casino game board according to claim 4, wherein the board is presented as part of a game played over a network with remotely-located players.
